(19) United States
(12) Patent Application Publication
(10) Pub. No.: US 2015/0378306 A1
(43) Pub. Date: Dec. 31, 2015

(54) METHOD FOR ILLUMINATION OF A HOLOGRAM IN HOLOGRAPHIC LITHOGRAPHY AND A MULTI-COMPONENT ILLUMINATOR FOR CARRYING OUT THE METHOD

(71) Applicant: Vadim Rakhovsky, Moscow (RU)

(72) Inventors: Igor GUREVICH, Saarbrucken (DE); Vadim RAKHOVSKY, Moscow (RU)

(21) Appl. No.: 14/320,575

(22) Filed: Jun. 30, 2014

(51) Int. Cl. G03H 1/04; G03H 1/20

(52) U.S. Cl. CPC G03H 1/0476; G03H 1/20; G03H 2001/205

(57) ABSTRACT

A method and a multi-component illuminator for illumination of a hologram in holographic lithography in which a coherent beam is split into a plurality of individual laser light beams by means of a beam splitter which is provided with a plurality of individual sub-illuminators. Each sub-illuminator has an individual aperture, receives a respective individual coherent light beam, and form a an illumination field on the surface of the hologram during hologram illumination. Altogether the sub-illuminators are combined into a common hologram illuminator. In the multi-component illuminator the individual sub-illuminators are arranged so that the illumination fields cover with the light the maximum possible surface of the hologram during illumination of the latter in the holographic lithography process.

### BACKGROUND OF THE INVENTION

1. Field of the Invention

The present invention relates to the field of optics, in particular to holographic lithography and, more specifically, to a method for illumination of a hologram in holographic lithography and to a multi-component illuminator for carrying out the method.

2. Description of the Related Art

Lithography and, in particular, photolithography is a well-known technique in semiconductor and printed circuit board (PCB) manufacture for creating electrical components and circuits. Photolithography involves placing a mask in front of a substrate, which has been covered by a layer of photoresist, before exposing both a mask and a substrate to light. The areas of photoresist that are exposed to light react and change chemical properties. The photoresist is then developed in order to remove either the exposed portions of photoresist for a positive resist or the unexposed portions for a negative resist. The pattern formed in the photoresist allows further processing of the substrate, such as, but not limited to, etching, deposition, or implantation.

One method of producing holographic images of integrated circuit (IC) topologies is disclosed in US Patent Application Publication 20110020736 (publication date of Jan. 27, 2011; inventors: Vadim Rakhovsky, et al). As mentioned in this publication, design of ICs with a characteristic element dimension of 0.1 to 0.01 micron is a major promising direction in current microelectronics development. The high-precision technology (having submicron and micron tolerances) of making precise forms with 3D relief can be used in developing mass production of microrobotic parts, high-resolution elements of diffraction and Fresnel optics, and in other technical fields requiring 3D IC layout of a specified depth and with high resolution of its structures in the functional layer of a device. The latter can be used, for instance, to produce printing plates for banknotes and other securities.

Further progress of up-to-date microelectronics strongly depends on the microlithography process resolution that defines the development level of a majority of current science and technology fields. Microlithography involves coating a solid body (usually a substrate made of a semiconductor material) with a layer of a material sensitive to the used radiant flow, optical radiation, or electron beams. More often, however, a photoresist layer is used to produce an image that corresponds to a specified topology, for example, the topology of a certain layer of the IC being produced. Exposure of the photoresist through a pattern, usually called “a mask”, makes this possible.

The positioning accuracy of the best projection scanning systems (steppers) made by ASML (The Netherlands), which is a leader in the field of microelectronics technology equipment, reaches 10 nm, which is explicitly insufficient for making VLSI ICs with a characteristic element dimension of 20 to 30 nm. The gap between of the steppers' abilities and the industry demand is intrinsic because three to five years are required to develop a stepper for submicron technologies and its cost for mass production, alone, is 10 to 70 million dollars, depending on the resolution required. The cost of development when added to the cost of production amounts to hundreds of millions of US dollars.

At present, photomicrolithography (or photolithography) is widely used in industry. The resolution Δx that it provides is determined by the wavelength λ of the radiation used and the numerical aperture NA of the projection system: Δx=κ₁λ/NA (W. Moro “Microlithography”; in 2 parts. Part 1: Transl. from English; Moscow. MIR, 1990, p. 478). Such dependence reasonably encouraged developers to use more and more shorter-wavelength radiation sources and more and more larger-aperture projection systems. As a result, for the last 40 years industrial projection photolithography has switched from using mercury lamps with a characteristic radiation wavelength of 330 to 400 nm to excimer lasers with an operating wavelength of 193 nm and even 157 nm. Projection lenses of modern steppers have reached 600 to 700 mm in diameter, which has caused a rapid increase in stepper cost.

There is a method of producing a binary hologram by generating a plurality of transmission areas at specified locations or earlier calculated positions on a film. The hologram is opaque to the used radiation in such a way that when illuminated, these transmission areas make it possible to produce a holographic image at a predetermined distance from these areas (L. M. Soroko, “The Fundamentals of Holography and Coherent Optics”; Moscow, Nauka, 1971, pp. 420-434). This monograph considers the possibility of producing a “numeric” hologram, also called a “synthetic”, “artificial”, or “binary” hologram, and sets forth the theory with the conciseness and clarity peculiar to mathematic descriptions. However, the known method of making binary holograms—wherein the image of the transmission areas is produced, for example, by graphical means and then photographed with a significant reduction—does not provide a desired image quality and high resolution primarily because of insufficient accuracy in its production and an insufficient number of transmission areas.

There is a method for producing an image on material that is sensitive to used radiation by a hologram. In this method, exposure spots are generated by imaging at least one hologram placed in front of the radiation-sensitive material (GB 1331076 A, publ. Sep. 19, 1973^{[3]}). However, the known method of using a hologram to provide an image on the material that is sensitive to used radiation does not allow production of high-quality images due to mutual overlapping of a plurality of diffraction orders, and due to the impossibility of using short-wave radiation sources. Moreover, the main objective of this method was to provide effective control of visually checked marks.

Also known is Russian Patent RU2396584 issued on Aug. 10, 2010 to M. Borisov, et al (equivalent to US Patent Application Publication 2011/0020736) which relates to a method for creating holographic images of drawings, wherein an image of the initial drawing is converted into a digital raster image. The diffraction pattern on each point of the future hologram is calculated, where the said diffraction pattern is created from all emitter elements of the digital raster image. Next to be calculated is the interference pattern obtained from interaction of the calculated diffraction pattern with the calculated wave front from a virtual reference point or extended radiation source, which is identical to the real wave front of the source and which will be used in producing the holographic image of the drawing. The result is used as a signal for modulating the radiation beam, which forms the diffraction structure of the hologram on a carrier. The hologram is composed of a set of discrete elements distinguished by their optical properties.

The apparatus for patterning a workpiece using an in-line holographic mask (ILHM) is disclosed in U.S. Pat. No. 5,015,049 issued to Byung J. Chang on May 14, 1991. This patent discloses a method of forming holographic optical elements free of secondary fringes. Holographic optical elements relatively free of unwanted, secondary fringes are produced by passing the light beam from a laser through a rotating diffusing plate to generate a beam of light having a very limited coherence length and a spatial coherence that changes over time. A photographic emulsion having a mirror supported on its reverse side is illuminated by the beam, and interference occurs between this primary illumination and illumination reflected from the mirror, thus creating fringes. No other interference fringes are formed because of the lack of coherence between secondary (REF)lections and other rays of the incident beam. The rotation of the diffusion plate time-averages to zero any random interferences, thus eliminating the speckle pattern. Alternatively, the illuminating beam has a high degree of spatial coherence but its temporal coherence is reduced and varied over a period of time by changing the wavelength of a tunable-dye laser.

U.S. Pat. No. 6,618,174 issued on Sep. 9, 2003 to William P. Parker, et al, discloses an optically made, high-efficiency in-line holographic mask (ILHM) for in-line holographic patterning of a workpiece and apparatus and methods for performing same. The ILHM combines the imaging function of a lens with the transmission properties of a standard amplitude mask, obviating the need for expensive projection optics. The ILHM is either a type I (nonopaque) or type II (opaque) specialized object mask having one or more substantially transparent elements that can be phase-altering, scattering, refracting, and/or diffracting. A method of creating a pattern on a workpiece includes the steps of disposing an ILHM, disposing a workpiece adjacent to the ILHM and illuminating the ILHM to impart a pattern to the workpiece. In another method, the ILHM is used in combination with a lens. The ILHM is disposed such that a holographic real image is formed at or near the lens object plane, and the workpiece is disposed at or near the lens image plane.

U.S. Pat. No. 7,312,021 issued on Dec. 25, 2007 to Shih-Ming Chang discloses a hologram reticle and method of patterning a target. A layout pattern for an image to be transferred to a target is converted into a holographic representation of the image. A hologram reticle is manufactured that includes the holographic representation. The hologram reticle is then used to pattern the target. Three-dimensional patterns may be formed in a photoresist layer of the target in a single patterning step. These three-dimensional patterns may be filled to form three-dimensional structures. The holographic representation of the image may also be transferred to a top photoresist layer of a top surface imaging (TSI) semiconductor device, either directly or using the hologram reticle. The top photoresist layer may then be used to pattern an underlying photoresist layer with the image. The lower photoresist layer is used to pattern a material layer of the device.

A method of generating a holographic diffraction pattern and a holographic lithography system are disclosed also in US Patent Application Publication 2008/0094674 (published on Apr. 24, 2008; inventors are Alan Purvis, et al). The method involves defining at least one geometrical shape; generating at least one line segment to represent the at least one geometrical shape; calculating a line diffraction pattern on a hologram plane, including calculating the Fresnel diffraction equation for an impulse representing the at least one line segment with a line width control term and a line length control term; and adding vectorially, where there are two or more line segments, the line diffraction patterns to form the holographic diffraction pattern. The method and system enables holographic masks to be generated without creating a physical object to record. The required shapes or patterns are defined in terms of a three-dimensional coordinate space, and a holographic pattern is generated at a defined distance from the shapes in the coordinate space.

U.S. Pat. No. 7,722,997 issued on May 25, 2010 to Shih-Ming Chang, et al, discloses a hologram reticle and method of patterning a target. A layout pattern for an image to be transferred to a target is converted into a holographic representation of the image. A hologram reticle is manufactured that includes the holographic representation. The hologram reticle is then used to pattern the target. Three-dimensional patterns may be formed in a photoresist layer of the target in a single patterning step. These three-dimensional patterns may be filled to form three-dimensional structures. The holographic representation of the image may also be transferred to a top photoresist layer of a top surface imaging (TSI) semiconductor device, either directly or using the hologram reticle. The top photoresist layer may then be used to pattern an underlying photoresist layer with the image. The lower photoresist layer is used to pattern a material layer of the device.

Known in the art is a method for synthesis and formation of a digital hologram for use in microlithography disclosed in pending U.S. patent application Ser. No. 14/142,776 filed on Dec. 28, 2013 by Vadim Rakhovsky, et al. This invention describes a method of manufacturing a holographic mask capable of producing an image pattern that contains elements of a sub-wavelength size along with decreased deviations from the original pattern. The original pattern is converted into a virtual electromagnetic field and is divided into a set of virtual cells with certain amplitudes and phases, which are mathematically processed for obtaining the virtual digital hologram. The calculation of the latter is based on parameters of the restoration wave, which is used to produce the image pattern from the mask, and on computer optimization by variation of amplitudes and phases of the set of virtual cells and/or parameters of the virtual digital hologram for reaching a satisfactory matching between the produced image pattern and the original pattern. The obtained virtual digital hologram provides physical parameters of the actual digital hologram that is to be manufactured.

As a further step in the development of the holographic lithography, the inventors of the previous patent application offered a new method of static scaling of an image obtained in holographic lithography (see pending U.S. patent application Ser. No. 14/267,884 filed by Vadim Rakhovsky, et al. on May 1, 2014).

The aforementioned patent application discloses a method of static scaling of an image in holographic lithography. The method consists of generating a final virtual digital hologram of the original pattern through a sequence of mathematical calculations with participation of a virtual coherent light source having a predetermined wavelength λ₁ and producing an actual hologram on the basis of the virtual digital hologram of the original pattern. The obtained hologram can be used for forming an actual original pattern in a predetermined size. When it is necessary to produce the original pattern in another size, this can be done by static scaling by merely selecting another wavelength for the laser source with adjustable wavelength. The method allows determining the wavelength range in which scalability is possible with substantially homotetic transformation of the image.

However, practical implementation of a lithograph that operates on holographic principle encounters a number of serious problems. One of such problems is creation of a laser illumination system with a large aperture. A large aperture is needed for obtaining a high resolution and decrease in overall dimensions to a practically acceptable level since increase in aperture leads to the overall dimensions of the system.

The terminology used herein is in compliance with one contained in pending U.S. patent application Ser. No. 14/142,776 filed on Dec. 28, 2013.

We can propose the following explanation of effect of illumination aperture on the image resolution in the holographic image restoration process. Let us consider a simple example of interference of two coherent light sources S₁ and S₂ (see FIG. 1) having the same intensity I₁ at a distance of 2d from each other. Let us assume that these are identical light sources S1 and S2, where x is a current coordinate of a point on the hologram. In this drawing, r2 is a distance to the current point from source S2, r1 is a distance from source S1 to the current point, and D is a distance from plane of the light sources to the hologram.

As has been shown and explained in aforementioned pending U.S. patent application Ser. No. (14/267,884 filed on May 1, 2014), the following formula can be derived for phases φ₁ and φ₂ of interfering waves:

$${Φ}_{1} - {Φ}_{2} \approx 2 kx sin ( A ) + \frac{kx {δ}^{2}}{{D}^{2}} sin ( 2 A ) cos ( A ) , \qquad ( 1 )$$

where δ is a half image size, k is a wave vector, and A is an aperture angle that can be found from the following formula:

$$1 + {( \frac{d}{D} )}^{2} = 1 + {tg}^{2} A = \frac{1}{{cos}^{2} A} .$$

A method for sufficiently accurate evaluation of function grayness on a hologram is know:

$$T \approx λ \frac{D}{δ} .$$

It is obvious that for sufficiently accurate transfer of the function of grayness during binarization, the period T of oscillations of the grayness function should cover at least several steps of the grid. That is, the grid spacing h≦T/3. It is also known [see: Weinstein “Electromagnetic waves”], that the application of Kirchhoff approximation requires that the size of the hole that form the hologram is not less than 1.7λ. Therefore, to preserve the dynamic range, it is necessary to observe the following condition: h≧2.5λ. Hence T≧7.5λ and D/δ≧7.5.

Let us take a first derivative of formula (1) with respect to x:

$$( {Φ}_{1} - {Φ}_{2} ) / \approx 2 k sin ( A ) + \frac{k {δ}^{2}}{{D}^{2}} sin 2 A cos A \approx 2 k sin A$$

On the interference picture, we will obtain a bright spot in an area where the waves from both light sources come in phase, i.e., φ₁−φ₂=0, and a dark spot will occur in an area where the waves come in a counter-phase, i.e., φ₁−φ₂=±π.

In a simplified form a distribution of intensity peaks can be presented as shown in FIG. 2. A unit used on an absicca axis for measuring distances is a a size of a strip (critical dimension (CD) or half pitch), and relative intensities are plotted on the ordinate axis.

As a result, when x on CD changes, the phase difference should change by π. Thus, 2 k sin A≈π/CD or

$$pitch \approx \frac{π}{k sin A} = \frac{λ}{2 NA} ,$$

which corresponds to the Relay criterion.

This reasoning is suitable for the simplest case. Please note that phases of neighboring peaks are opposite to each other, and this provides a contrast between them.

As has been shown in the aforementioned pending patent application, the synthesis of a hologram is carried out by simulating illumination of a hologram plane with a plurality of light sources. A field which is obtained as a result of the simulation, can be linked to the Fourier function of distribution of sources on a restored image as shown in FIG. 3.

In this drawing, f(x₁, x₂) is a function that describes distribution of light sources on a virtual image of their amplitudes and phases; F(k₁, k₂) is a Fourier distribution. Axes k₁ and k₂ coincide with axes x₁ and x₂! A radius of a hemisphere with the center in the point of the coordinate-system origin is equal to a wave number k. The function coordinates F(k₁, k₂) can be projected onto the hemisphere perpendicular to the image plane and then centrally to the hologram plane and then multiplied by a phase factor e^{-ikξ-ikη}, where ξ and η are coordinates of a respective point on the hologram.

Thus, the expansion of the frequency spectrum of the function describing the distribution of sources on the image is accompanied by expansion of the aperture angle as well (FIG. 4).

Such images require more complicated coloring of phase elements, and this means that distribution of virtual light sources will have a wider frequency spectrum. This statement can be clarified by reference to the function graph shown in FIG. 5.

The function shown in FIG. 5 illustrates the simplest phase distribution model used for illustrating the factors that affects the aperture. The Fourier transform graph for this function is shown in FIG. 6.

As can be seen from this graph, the fundamental frequencies are concentrated in two peaks which are located close to each other.

Let us consider a function the amplitude part of which coincides with the previous one but the phase factors are different. Let us change the phase with the pitch equal to 2π/3 (see FIG. 7). The Fourier transform of this function is shown in FIG. 8.

One can observe an essential expansion of the spectrum. This means that at the same CD an image with a smaller phase shift will require a greater amplitude. This conclusion is confirmed by numerical calculations. Practice shows that a subwave image with small or continuous phase shifts between the elements requires that the following condition is observed: NA>0.7.

In instruments, the term “objective” is an optical element that gathers light from the object being observed and focuses the light rays to produce an Objectives can be single lenses or mirrors, or combinations of several optical elements.

In the context of the present application the term “objective” means an illuminator that focuses the light beam on an object, and the term single-unit” means a single one-lens or multiple-lens optical objective as defined above in the meaning of a “single illuminator”.

However, manufacturing of a single illuminator with an aperture NA>0.7 which is able to illuminate the entire hologram having dimensions suitable for practical use in lithography will be a very technically complicated and economically very expensive procedure comparable with manufacture of an objective for a modern optical nanolithograph. The cost of such an objective may be as high as $10M. Therefore, transfer to methods and devices for nano-patterning alternative to traditional projection methods and devices such as holography-based methods and devices that will provide an essential decrease in costs and improvement in optical properties of the products is an urgent task of the industry.

It is known to increase the aperture of an optical apparatus by dividing an optical beam used in the system into several channels by using a plurality of individual optical sub-systems with subsequent collection of the sub-beans into a single one that can be used for creating an image, e.g., in astronomy.

Thus, U.S. Pat. No. 7,119,955 issued on Oct. 10, 2006 to Robert Sigler, et al. discloses a multi-aperture high-fill-factor telescope. Specifically a multi-aperture high-fill-factor telescope is provided that includes a plurality of sub-aperture telescopes, each sub-aperture telescope being configured to collect electromagnetic radiation from a scene and including first, second, third, and fourth powered mirrors; a set of combiner optics configured to combine electromagnetic radiation collected by the sub-aperture telescopes to form an image of the scene; and a plurality of sets of relay optics, the sets of relay optics are respectively associated with the sub-aperture telescopes and each set of relay optics includes a first flat fold mirror, a trombone mirror pair, and a last flat fold mirror, wherein the last flat fold mirrors are disposed within about a beam diameter of respective exit pupils of the sub-aperture telescopes. However, as is well known, in holographic lithography the illumination light must be coherent and therefore the systems and subsystems of U.S. Pat. No. 7,119,955, or other known systems of this type are not applicable to holographic lithography.

### SUMMARY OF THE INVENTION

The present invention relates to the field of optics, in particular to holographic lithography and, more specifically, to a method for illumination of a hologram in holographic lithography and to a multi-component illuminator for carrying out the method.

A multi-component illuminator of the present invention for illumination of a hologram in holographic lithography contains a laser light source that generates a coherent light beam. This beam is expanded by a beam expander that is installed on the path of the beam emitted from the laser source. The illuminator further contains a beam splitter that splits the coherent light beam into a plurality of individual coherent light beams that are distributed between individual sub-illuminators. For the purposes of the invention the beam splitter may have any design provided that it is capable of splitting the coherent light beam into a plurality of individual coherent light beams. Each sub-illuminator contains at least an optical objective that focuses the individual coherent light beam into a focusing point common for all sub-illuminators of said plurality. Each focusing device has an individual aperture and a focal length. The individual apertures of the focusing devices may be the same or different. The sub-illuminators are arranged so that the illumination fields produced by the light emitted from all the sub-illuminators cover the illuminated surface as much as possible without non-illuminated areas. For example, the sub-illuminators may be arranged in a hexagonal structure. In this hexagonal structure at least one of the focusing devices that has an aperture different from the apertures of other focusing devices may contain a phase equalizer. In the hexagonal structure the multi-component illuminator may contain a central sub-illuminator which is surrounded by six peripheral individual sub-illuminators.

The beam splitter may comprise a first mirror and a second mirror in each individual sub-illuminator, wherein both mirrors are inclined at certain angles to the direction of the incoming coherent laser beam and redirect each split individual laser beam toward the respective focusing device, i.e., the optical objective of the respective sub-illuminator. The first mirrors of all individual sub-illuminators have mirror surfaces on the outer sides and are combined into a single unit in the form of a first truncated multifaceted cone, while the second mirrors of all individual sub-illuminators have mirror surfaces on the inner sides and are combined into a single unit in the form of a second truncated multifaceted cone.

A method of the invention for illumination of a hologram in holographic lithography comprises the steps of: providing a laser beam of coherent light; splitting this beam into a plurality of individual laser light beams having individual apertures; providing a plurality of individual sub-illuminators each of which receives a respective individual coherent light beam; combining the individual sub-illuminators into a common hologram illuminator, each individual sub-illuminator having an individual aperture; and illuminating the hologram by focusing the individual laser beams into a common focusing point thus increasing the aperture of the common holographic illuminator, each individual sub-illuminator forming an illumination field on the surface of the hologram during hologram illumination. Further steps consist of arranging the individual sub-illuminators into pattern that provides the maximal light covering of the illuminated hologram with their illumination fields.

An additional step may be comprised of providing seven individual sub-illuminators with one central individual sub-illuminator which has a longitudinal axis that passes through the common focusing point and six peripheral sub-illuminators and arranging the peripheral sub-illuminators at an angle to said longitudinal axis for complying with the condition of focusing into a common focusing point. All sub-illuminators may have the same or different apertures, and for decreasing the non-illuminated zones, some illumination fields produced by the individual sub-illuminators, e.g., by the central sub-illuminator, may slightly overlap the illumination fields of other sub-illuminators, and thus cover the zones between the central illumination field and the peripheral fields which otherwise are non-illuminated.

### BRIEF DESCRIPTION OF THE DRAWINGS

FIG. 1 is a diagram for explaining the effect of illumination aperture on the image resolution in the holographic image restoration process.

FIG. 2 is a graph that shows a simplified form of intensity peak distribution on the interference picture.

FIG. 3 is a view that shows that a field which is obtained as a result of the simulation can be linked to the Fourier function of distribution of sources on a restored image.

FIG. 4 is a view that shows that the expansion of the frequency spectrum of the function describing the distribution of sources on the image is accompanied by expansion of the aperture angle as well.

FIG. 5 is a function that illustrates the simplest phase distribution model used for illustrating the factors that affects the aperture.

FIG. 6 is a Fourier transform graph for the function shown in FIG. 5.

FIG. 7 shows a function, the amplitude part of which coincides with the previous one but the phase factors change the phase with the pitch equal to 2π/3.

FIG. 8 shows a Fourier transform of the function shown in FIG. 7.

FIG. 9 is a simplified scheme of an apparatus of the invention.

FIG. 10 is a simplified scheme of a conventional single-objective illuminator that contains one optical objective and produces a single coherent light beam.

FIG. 11 illustrates in a three-dimensional view of a densely packed wide-aperture illuminator that consists of sub-illuminators in which a central sub-illuminator, which is not shown, is surrounded by six peripheral sub-illuminators, only four of which are seen in the drawing.

FIG. 12 is a principle two-dimensional view of the apparatus of FIG. 11.

FIG. 13 is a view of illumination fields produced by the individual sub-illuminators of the apparatus of the invention.

FIG. 14 is a simplified view of an apparatus of the present invention which contains a central optical objective of a special geometry different from the geometry of the objectives of other sub-illuminators.

FIG. 15 is a view similar to one shown in FIG. 13 but with the central illumination field that is produces by the central objective of the apparatus of FIG. 14 and that overlaps the illumination fields produced by the peripheral sub-illuminators.

FIG. 16 is a three-dimensional mirror assembly in the form of a multifaceted truncated cone

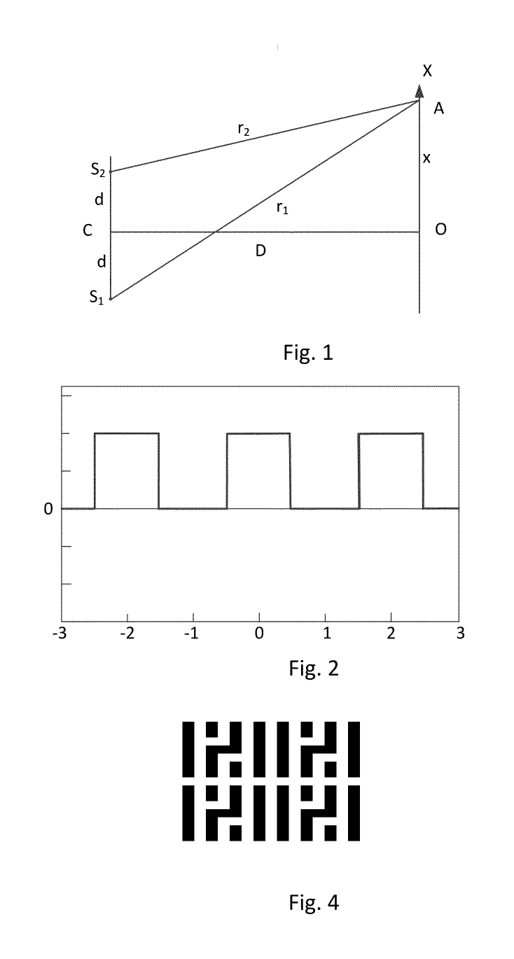

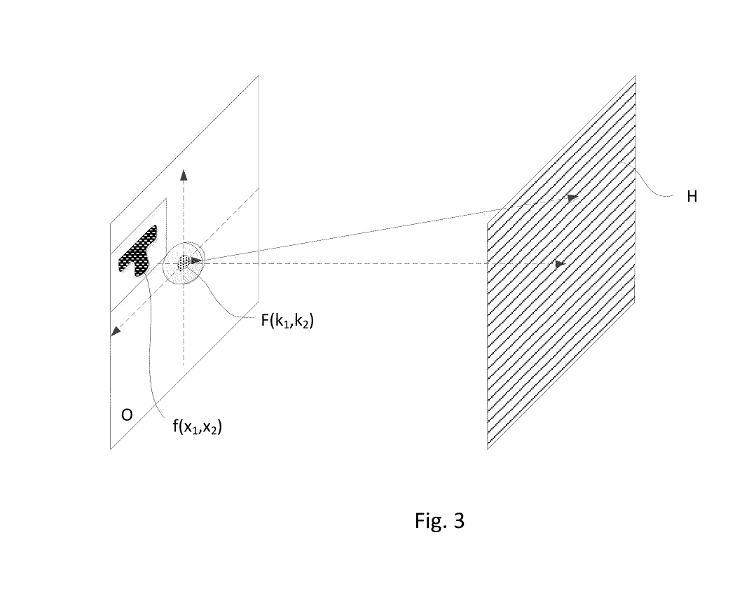

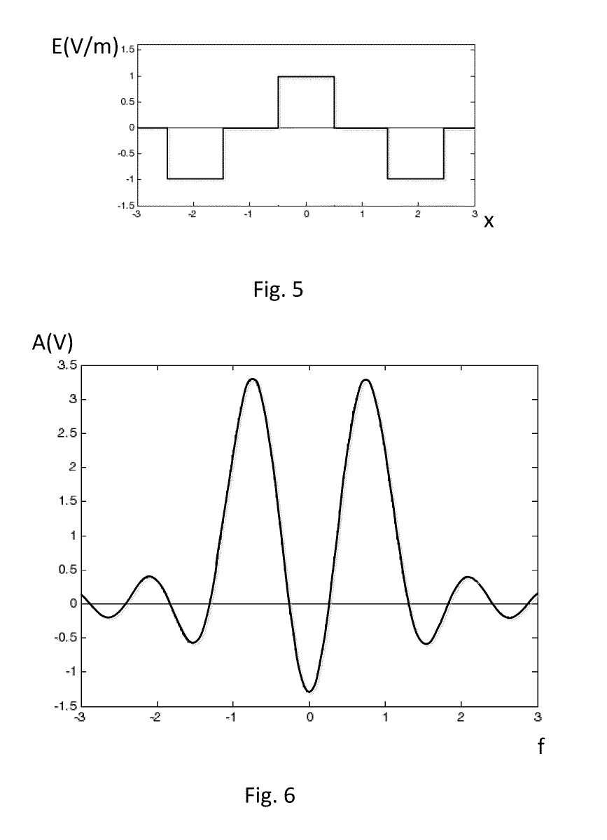

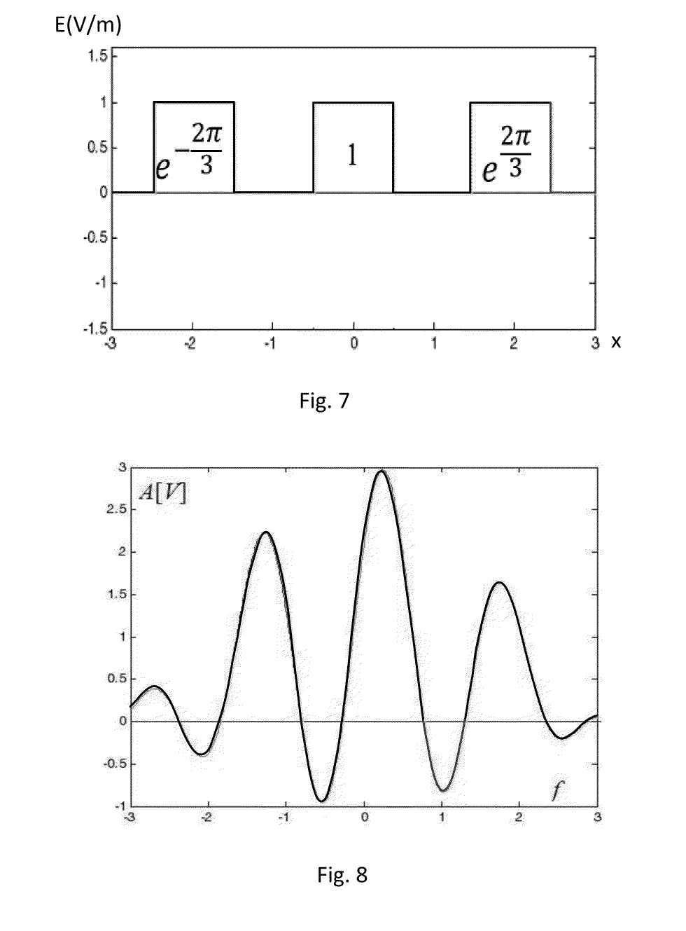

### DETAILED DESCRIPTION OF THE INVENTION

The present invention relates to a method and apparatus for increasing effective aperture of an illuminator suitable for use in holographic lithography.

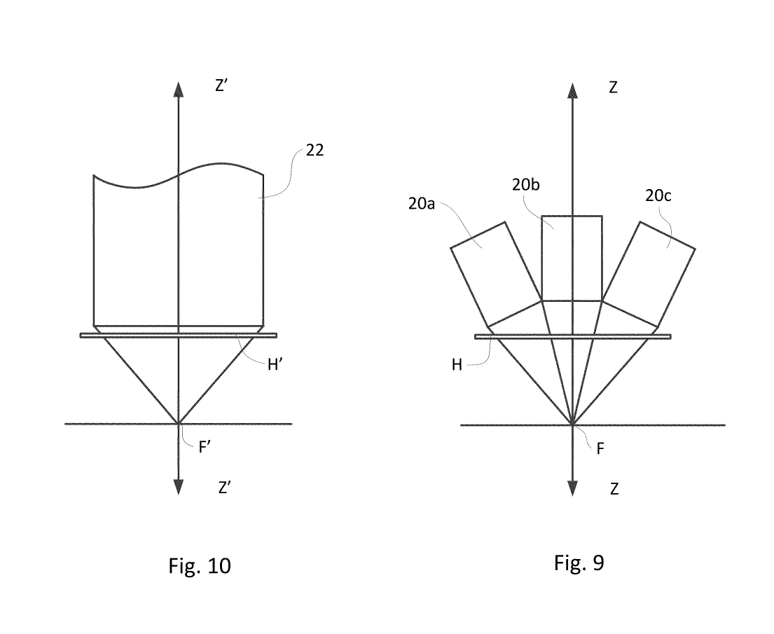

The apparatus of the invention, which comprises a multi-component illuminator for use in holographic lithography (hereinafter referred to merely as “an apparatus”) will now be described with reference to the accompanying drawings, where FIG. 9 is a simplified scheme of an optical illuminator 20 for holographic lithography consisting of seven sub-illuminators, only three of which, i.e., 20a, 20b, and 20c are seen in this section shown only in the form of objectives. Strictly speaking, each sub-illuminator consists of a focusing device, i.e., an optical objective having an individual aperture, a group of mirrors, and a common laser light source the beam of which is split between individual sub-illuminators. These sub-illuminators are designed for replacing a conventional single-objective illuminator 22 shown in FIG. 10 and produce individual coherent light beams.

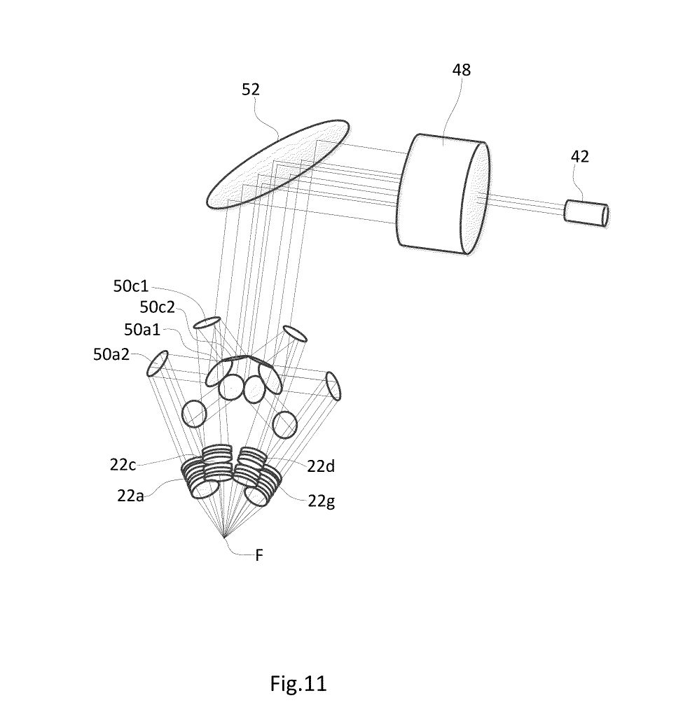

FIG. 11 illustrates in a three-dimensional view a densely packed wide-aperture illuminator 20 that consists of sub-illuminators in which a central sub-illuminator, i.e., 20b (not shown), is surrounded by six peripheral sub-illuminators 20a, 20b . . . 20g.

Each of these seven sub-illuminators, including those shown in FIG. 9, has the same numerical aperture NA so that in combination a summarized aperture of all sub-illuminators will be equal approximately to (3×NA). It can be seen from FIGS. 9 to 11 that this tripled aperture (3×NA) should correspond to the aperture of the single-objective illuminator 22 of FIG. 10, the manufacture of which, as mentioned above, is more expensive and much more complicated as compared to the apparatus of FIG. 9 for the reasons explained below.

It is understood that four, i.e., 22a, 22c, 22d, and 22g, of seven sub-illuminators

are shown only for simplicity of the drawing and that seven sub-illuminators are also mentioned as an example. For example, the apparatus may contain as many sub-illuminators as possible for practical design and required by the purpose of the final apparatus. The number of the subsystems is also selected from the condition of density of packing them into an optical assembly which leave on the surface of the object, in this case, of the hologram H, a minimal non-illuminated area. From this point of view in case of a hexagonal packing the number of sub-illuminators may be equal, e.g., to nineteen.

In the simplified form of the multi-objective illuminator 20 all sub-illuminators 20a, 20b,20c, etc., are optically identical and have the same focus distances. They are supposed to be focused to the same point F on the axis Z-Z, and the hologram H (see FIG. 9) is to be placed between the focus point F and the lower ends of the sub-illuminators. It is understood that the individual light beams emitted by all sub-illuminators are coherent as they are originated from a laser source.

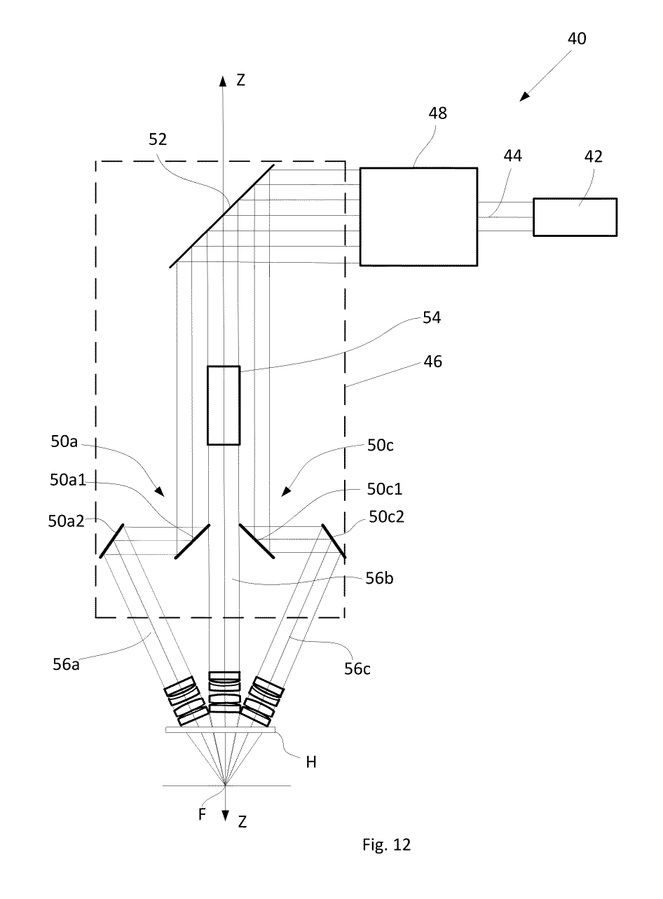

A principle diagram of the apparatus of the invention for increasing effective aperture of illuminator for holographic lithography is shown in FIG. 12, where the apparatus as a whole is designated by reference numeral 40. It can be seen that the apparatus consists of a laser light source 42 that emits a coherent laser light beam 44 to a beam splitters 46 through a beam expander 48. In the modification shown in FIG. 12 the beam splitter 46 comprises a system of a plurality of mirror groups, of which only two groups 50a and 50c of mirrors are shown, wherein each group contains at least two mirrors, e.g., the group 50a contains mirrors 50a1, 50a2 and the group 50c contains mirrors 50c1, 50c2. The system 40 may optionally include a fold mirror 52 and a phase equalizer 54 located between the fold mirror 52 and the mirror groups 50a and 50c. The equalizer may be contained, e.g., in the focusing device that has an aperture different from the apertures of other focusing devices.

The beam splitter 46 divides the coherent laser beam 44 emitted from the laser source 42 into a plurality of individual coherent light beams, seven in the illustrated case of which only three, i.e., component beams 56a, 56b, and 56c are shown in FIG. 12. In this case, the mirrors 50a1, etc. and 50c1, etc. split the laser beam 44 into six components while the central, i.e., the seventh beam component 56b passes without reflection. The mirror 50a1, 50a2, etc. and 50c1, 50c2 are inclined to the direction of the central beam 56b so that the peripheral beams and the central beam are all focused into a common focal point F on the axis Z-Z.

The phase equalizer 54 may comprise a standard unit in the form of a mirror system that equalizes the length of the beam path (beam 56) in the central channel with the length paths of the peripheral beams (beams 56a and 56b).

Focusing of the component beams 50a, 50b, and 50c (and the remaining four beams not shown in FIG. 12) is carried out by means of respective optical objectives, only three of which, i.e., objectives 58a, 58b, and 58c, are shown. The mirrors 50a1, 50a2 and the objective 58a form the aforementioned sub-illuminator 22a of FIG. 11. Similarly, the mirrors 50c1, 50c2 and the objective 58c form the sub-illuminator 22c of FIG. 11, etc.

It can be seen that in the optical system shown in FIG. 12 is axially symmetrical relative to the axis Z-Z of the central beam 58b, and point F lays on this axis. The objectives 58a, 58b, 58c, etc. are identical and, as mentioned above, focus the beams into a common point F. It should be noted that each objective should be free of aberrations.

The apparatus 40 of FIG. 12 is intended for illumination of the hologram H, which is placed into a position shown in FIG. 9.

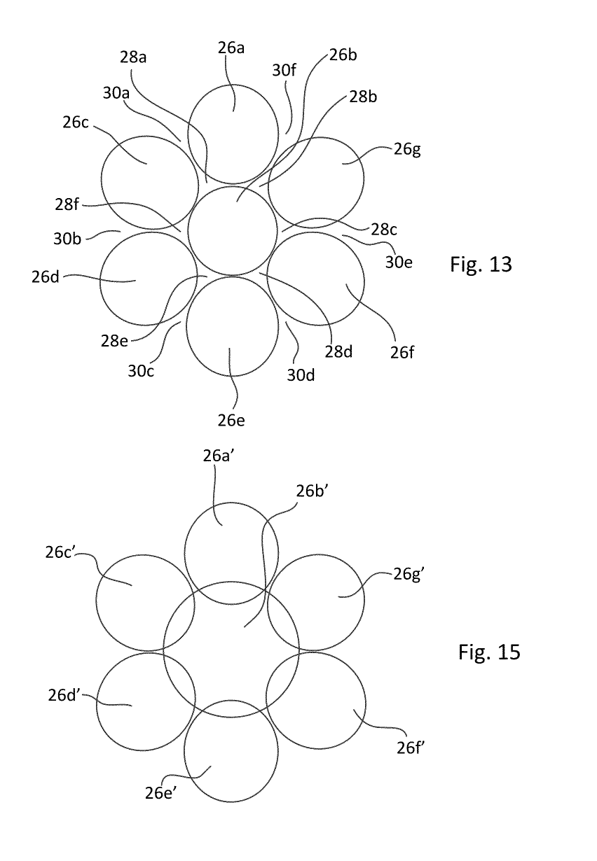

The illumination field 70 produced by the apparatus of the invention 40 of the invention shown in FIG. 13. It consists of six elliptical illumination sub-fields 26a, 26c, 26d, 26e, 26f, 26g and a circular central sub-field 26b. The peripheral sub-fields are elliptical because the peripheral beams are inclined with respect to the central beam.

As mentioned above, the system shown in FIG. 12 will have an aperture which is about three times the aperture of a single objective system and which has much smaller overall dimensions. This system is intended for use in holographic lithography, e.g., for restoration of a pattern recorded hologram. The advantage of using such a system is its structural simplicity in comparison with the conventional systems of this type with large-diameter objectives which are much more expensive in the manufacture.

In the modification shown in FIGS. 11 and 12, the illumination fields produced by sub-illuminators cannot completely cover the entire surface of the hologram and leaves insignificant dead zones 28a, 28b, 28c, 28d, 28e, 28f, 30a, 30b, 30c, 30d, 30e, and 30f. In principle, the shape and number of the sub-illuminators do not affect the restoration of an image with the use of a hologram because this image is reproduced independently by any point of the hologram.

What is critical in this issue is an agreement between the calculated and actual positions of the sub-fields 26a, 26c, 26d, 26e, 26f, 26g and a circular central sub-field 26b and compliance calculation and the actual amplitude and phase distributions in the restoration wave used in the method described in aforementioned pending U.S. patent application Ser. No. 14/142,776.

In sub-wavelength holographic lithography, for use in which the apparatus of the invention is intended, the plane of the mask and the image plane are not optically conjugated. However, in first approximation these planes may be considered linked through the Fourier transform. Thus, the dead zones on the operation field of the hologram cannot lead to any discontinuations in the image field. Moreover, in this case the Fourier analysis of the system makes it possible to define restrictions imposed on the spatial spectrum of the image.

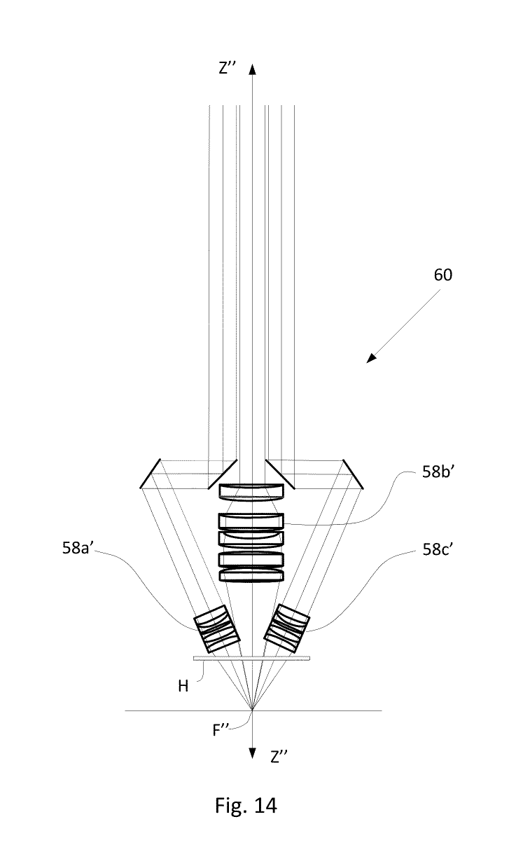

Spatial frequencies in the structure of the image corresponding (in this optical arrangement) to intervals between the sub-fields cannot be reproduced. Probably, the maxima that participate in the formation of certain parts of the image can be achieved by using special steps of virtual operations described in aforementioned pending patent application Ser. No. 14/142,776. However, if necessary, the dead zones can be significantly reduced without departing from the principle of the invention. Such a system 60, is shown in FIG. 14, where above goal is decided by providing a central objective 58b′ that has a special geometry. Structurally the system 60 is the same as system 40 shown in FIG. 12 and has the same number of mirrors and objectives, which, therefore can be designated by the same reference numerals with the addition of a prime. In FIG. 14, however, only three objective out of seven are shown. Reference numeral 50a2′, 50c2′ designate mirrors of respective sub-illuminators. Similarly, reference numerals 58a′, 58c′ show inclined objectives.

At least one of the focusing devices, i.e., optical objectives, e.g., the optical objective 58b′, has an aperture different from the apertures of other focusing devices.

The illumination sub-fields 26a′, 26b′, 26c′, 26d′, 26e′, 26f, and 26g′ produced by the multi-objective illumination system 60 are shown in FIG. 15. It can be seen that the central sub-field 26b′ of the system 60 overlaps a part of the dead zones between the peripheral sub-fields and the central sub-field of the system 40 shown in FIG. 12. In this case, the provision of the overlapped zones will lead to the formation of some regular areas of increased brightness. However, this problem can be solved on the design stage of the hologram by a method described in aforementioned pending U.S. patent application Ser. No. 14/142,776.

Furthermore, decrease of non-overlapped zones in the system of FIGS. 13, 14, and 15 is achieved due to special design of the central objective 58b′. This objective should be an aberration-free objective in order to preserve coherence of the radiated beam.

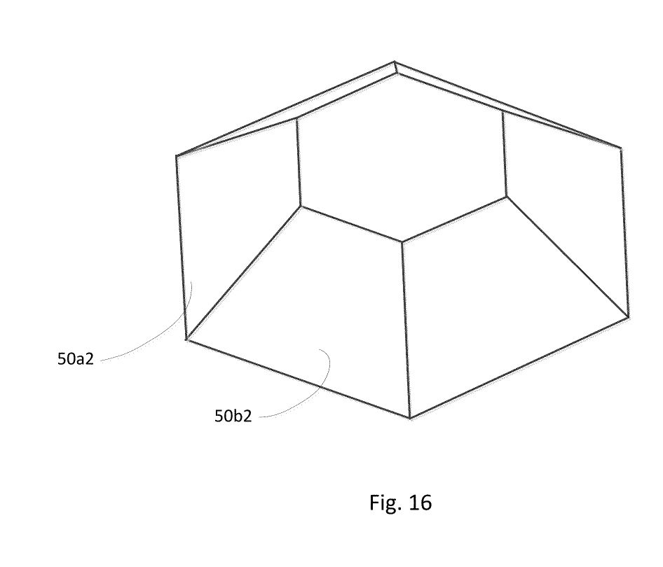

For simplicity of the drawings and observation of ray tracings In FIGS. 12 and 14 the mirrors 50a1, 50b1, 50a2, 50c2, etc., 50a1′, 50b1′, etc. are shown as separate elements. In a real construction however, the outer mirrors such as 50a2, 50c2, etc. (FIG. 12) and inner mirrors such as 50a1, 50c1, etc. are formed as integral assemblies of the type shown in FIG. 16 in the form of a multi-faceted truncated cone. This is possible because the mirror system of the sub-illuminators described above is an axially symmetrical system composed of identical mirrors inclined to the vertical central axis Z-Z and equal angles. The same is true for mirrors 50a1′, 50b1′, 50a2′, 50c2′, etc. shown in FIG. 14. The difference is that in one integral unit the mirror surfaces are on the outer side and in the other on the inner side of the integral assemblies.

Thus, the apparatus 40 (FIG. 12) of the invention comprises two mirror assemblies of the type shown in FIG. 16 with the difference that apart from the difference in dimensions the lower-level mirrors 50a1, 50c1, etc. have their mirrors surfaces on the outer side, while the upper-level mirrors 50a2, 50c2, etc. have their mirrors surfaces on the inner side. Each assembly has a shape of a multifaceted truncated cone, one of which has mirrors on the inner-side facets and another on the outer-side facets.

It can be seen from the structure of the apparatus described above that the method of the invention consists of combining the individual sub-illuminators into a common hologram illuminator, each having an individual aperture; and illuminating the hologram by focusing the individual laser beams into a common focusing point thus increasing the aperture of the common holographic illuminator, each individual sub-illuminator forming an illumination field on the surface of the hologram during hologram illumination.

Although the invention has been shown and described with reference to specific embodiments, it is understood that these embodiments should not be construed as limiting the areas of application of the invention and that any changes and modifications are possible provided that these changes and modifications do not depart from the scope of the attached patent claims. For example, the beam splitters can be different from the mirror system. The sub-illuminators can be arranged into a pattern different from hexagonal. The multi-component illuminator may contain the sub-illuminators in an amount different from six or seven and may not contain the central sub-illuminator at all.

What is claimed is:

1. A multi-component illuminator for illumination of a hologram in holographic lithography comprising: a laser light source that generates a coherent light beam; a beam expander that receives and expands the coherent light beam into an expanded coherent light beam; a beam splitter that splits the expanded coherent light beam into a plurality of individual coherent light beams and comprises a plurality of sub-illuminators that receive the expanded coherent light beams, each sub-illuminator comprises at least a focusing device that focuses the individual coherent light beam into a focusing point common for all sub-illuminators of said plurality, each focusing device having an individual aperture and a focal length.

2. The multi-component illuminator of claim 1, wherein the individual apertures of the focusing devices are the same.

3. The multi-component illuminator of claim 1, wherein at least one of the focusing devices has an aperture different from the apertures of other focusing devices.

4. The multi-component illuminator of claim 2, wherein the sub-illuminators are arranged in a hexagonal structure.

5. The multi-component illuminator of claim 3, wherein in the hexagonal structure said at least one of the focusing devices that has an aperture different from the apertures of other focusing devices contains a phase equalizer.

7. The multi-component illuminator of claim 5, wherein the hexagonal structure is further provided with a central sub-illuminator which is surrounded by six peripheral individual sub-illuminators.

8. The multi-component illuminator of claim 7, wherein the central sub-illuminator has a larger focal distance than other six individual sub-illuminator.

9. The multi-component illuminator of claim 9, wherein the beam splitter comprises a first mirror and a second mirror in each individual sub-illuminator, the first mirror being inclined to the direction of the coherent light beam and reflecting this individual coherent light beam to the second mirror which reflects the coherent light beam obtained from the first mirror toward the focusing device of the same individual sub-illuminator, the first mirrors of all individual sub-illuminators having mirror surfaces on the outer sides and being combined into a single unit in the form of a first truncated multifaceted cone, and the second mirrors of all individual sub-illuminators having mirror surfaces on the inner sides and being combined into a single unit in the form of a second truncated multifaceted cone.

10. A method of illumination of a hologram in holographic lithography comprising: providing a laser beam of coherent light; splitting this beam into a plurality of individual laser light beams having individual apertures; providing a plurality of individual sub-illuminators each of which receives a respective individual coherent light beam; combining the individual sub-illuminators into a common hologram illuminator, each having an individual aperture; and illuminating the hologram by focusing the individual laser beams into a common focusing point thus increasing the aperture of the common holographic illuminator, each individual sub-illuminator forming an illumination field on the surface of the hologram during hologram illumination.

11. The method of claim 10, comprising the step of arranging the individual sub-illuminators into a pattern that provides the maximal light covering of the illuminated hologram with their illumination fields.

12. The method of claim 10, comprising the step of providing seven individual sub-illuminators with one central individual sub-illuminator which has a longitudinal axis that passes through the common focusing point and six peripheral sub-illuminators and arranging the peripheral sub-illuminators at an angle to said longitudinal axis for complying with the condition of focusing into a common focusing point.

13. The method of claim 11, comprising the step of providing all sub-illuminators with the same individual aperture.

14. The method of claim 12, wherein the central individual illuminator has an aperture greater than the apertures of other individual sub-illuminators.

15. The method of claim 10, further providing a phase equalizer on the way of the coherent light beam to the individual sub-illuminators.

16. The method of claim 14, further providing a phase equalizer on the way of the coherent light beam to the individual sub-illuminators.
